(19) United States
(12) Patent Application Publication
(10) Pub. No.: US 2019/0052952 A1
(43) Pub. Date: Feb. 14, 2019

(54) HEAD REST PHONES

(71) Applicant: Panasonic Automotive Systems Company of America, Division of Panasonic Corporation of North America, Peachtree City, GA (US)

(72) Inventors: KATHERINE JENNETTE FREUND, LIVONIA, MI (US); MARK ZIEMBA, LIVONIA, MI (US)

(73) Assignee: Panasonic Automotive Systems Company of America, Division of Panasonic Corporation of North America

(21) Appl. No.: 16/102,994

(22) Filed: Aug. 14, 2018

Related U.S. Application Data
(60) Provisional application No. 62/545,291, filed on Aug. 14, 2017.

(51) Int. Cl. H04R 1/10

(52) U.S. Cl. CPC H04R 1/1091; H04R 1/1008; H04R 2420/07; H04R 1/105; H04R 2499/13; H04R 1/1041

(57) ABSTRACT

A motor vehicle includes headphones having two speakers. The headphones are selectively retained by the seat of the motor vehicle or worn by a human passenger of the motor vehicle. An audio source is communicatively coupled to the headphones and provides audio content to the headphones. A characteristic of the audio content as received by the speakers is dependent upon whether the headphones are being retained by the seat or worn by the passenger.

### CROSS-REFERENCED TO RELATED APPLICATIONS

This application claims benefit of U.S. Provisional Application No. 62/545,291 filed on Aug. 14, 2017, which the disclosure of which is hereby incorporated by reference in its entirety for all purposes.

### FIELD OF THE INVENTION

The disclosure relates to an audio system in a motor vehicle, and, more particularly, audio speakers associated with a seat or headrest in a motor vehicle.

### BACKGROUND OF THE INVENTION

Current headphones do not have enough sound pressure level (SPL) or correct equalization to be used as loudspeakers when not in intimate contact with the ears. Current in-vehicle original equipment manufacturer (OEM) headphones also do not have a native way to charge and typically do not use rechargeable batteries. Moreover, it is problematic for very young children to use current headphones because the headphones are prone to falling off children's heads, getting damaged, having batteries getting lost, and/or potentially damaging the children's hearing.

Current in-vehicle headphones are typically of low quality, require battery changes, and are easily lost. Current headrest speakers are single-purposed and not well-isolated.

### SUMMARY

The present invention may provide an audio system in a vehicle including a set of headphones that can rotate and attach to an automotive seat headrest or seat and become headrest speakers. The amplifier driving the headphone drive units may change its setting dependent upon the orientation of the earcups. Similarly, active noise cancellation (ANC) and audio tunings may be changed when the headphones are attached to the headrest or vehicle seat, which is the headphones' captive or stored position. When in “headphone” mode, the headphones may still use the in-vehicle audio source. The headphones may charge an internal battery when attached to the headrest. The headphones may produce an audible alert when being removed from the vehicle.

The invention may use specialized drive units, which are more powerful than known headphone drive units. The inventive headphones may also automatically adjust equalization. These two features may enable the inventive headphones to be used as both headphones and loudspeakers.

The invention may enable the listener to have the private audio experience that they choose, which may utilize either headphones for providing total isolation and privacy, or headrest-mounted or seat-mounted loudspeakers for providing a lower level of privacy and isolation.

The invention may enable several listeners to listen to their chosen audio source without others also hearing the audio and becoming annoyed thereby.

The invention may enable listeners to use the speaker mode to relieve the discomfort of wearing headphones, which may involve sweating, pinching, and/or pressure from the headphones.

The invention may enable young children to use headphones with reduced risk of the headphones falling off the children's heads, getting damaged, having batteries getting lost, and/or potentially damaging children's hearing.

The invention may provide a native headphone “docking” position which enables battery recharging to occur easily. Many listeners may choose to listen to the headphones in this docked position, enabling the batteries to charge and increasing battery life.

The headphones may be connected to the in-vehicle entertainment system, so the driver can talk to a user of the headphones by activating an In-Cabin Communication (ICC) feature. Because of the close proximity of the headphones to the listener's ears, the inventive system may be more effective in facilitating in-cabin communication than known audio system speakers.

The headphones may combine headrest speakers and in-vehicle headphones, and thereby may provide higher quality headphones that can serve multiple purposes in the car.

The inventive headphones may determine the delivered SPL in both the headphones mode and the speaker mode. Accordingly, the inventive headphones may limit the maximum SPL, thus protecting the listeners, especially children, from hearing damage.

The inventive headphones may be used outside of the vehicle as Bluetooth headphones or as a portable Bluetooth speakers.

The inventive headphones may be physically attached to the headrest so that the headphones are immovably retained by the headrest, yet the user is still able to manually remove and/or detach the headphones from the headrest in order to wear the inventive headphones like conventional headphones are worn.

The inventive headphones may be noise-cancelling when in the headphone mode. The audio system may have several microphones for communication with the headphones and/or for applying ANC to the headphones.

The inventive audio system may automatically change its settings in response to the earcups of the headphones being turned inward or outward.

The inventive headphones may be physically keyed so that the speakers of the headphones can sit only in the correct position within the headrest. There may be a driver-enabled physical lock to retain the headphones within the headrest in the headrest mode. There may also be a driver-enabled software lock to retain the operation of the headphones within the headrest mode.

In one embodiment, the invention comprises a motor vehicle including headphones having two speakers. The headphones are selectively retained by the seat of the motor vehicle or worn by a human passenger of the motor vehicle. An audio source is communicatively coupled to the headphones and provides audio content to the headphones. A characteristic of the audio content as received by the speakers is dependent upon whether the headphones are being retained by the seat or worn by the passenger.

In another embodiment, the invention comprises an audio method for a motor vehicle, including providing headphones including two speakers. The headphones are selectively retained by a seat of the motor vehicle or worn by a human passenger of the motor vehicle. Audio content is transmitted to the headphones. A characteristic of the audio content as received by the speakers is dependent upon whether the headphones are being retained by the seat or worn by the passenger.

In yet another embodiment, the invention includes a motor vehicle having a seat and headphones. The headphones include two driver devices and two speakers. Each driver device drives a respective one of the speakers. The headphones are selectively retained by the seat or worn by a human passenger of the motor vehicle. Determining means determines whether the headphones are being retained by the seat or are being worn by the passenger. An audio source is communicatively coupled to the headphones and provides audio content to the headphones. An electronic parameter of the two driver devices is dependent upon whether the headphones are being retained by the seat or are being worn by the passenger as determined by the determining means.

### BRIEF DESCRIPTION OF THE DRAWINGS

A better understanding of the present invention will be had upon reference to the following description in conjunction with the accompanying drawings.

FIG. 1 is a block diagram of one embodiment of a vehicular headphone arrangement of the present invention.

FIG. 2 is a perspective view of the headphones of the arrangement of FIG. 1, and a seat headrest in which the headphones may be installed.

FIG. 3 is a flow chart of one embodiment of an audio method of the present invention for a motor vehicle.

### DETAILED DESCRIPTION OF THE PREFERRED EMBODIMENTS

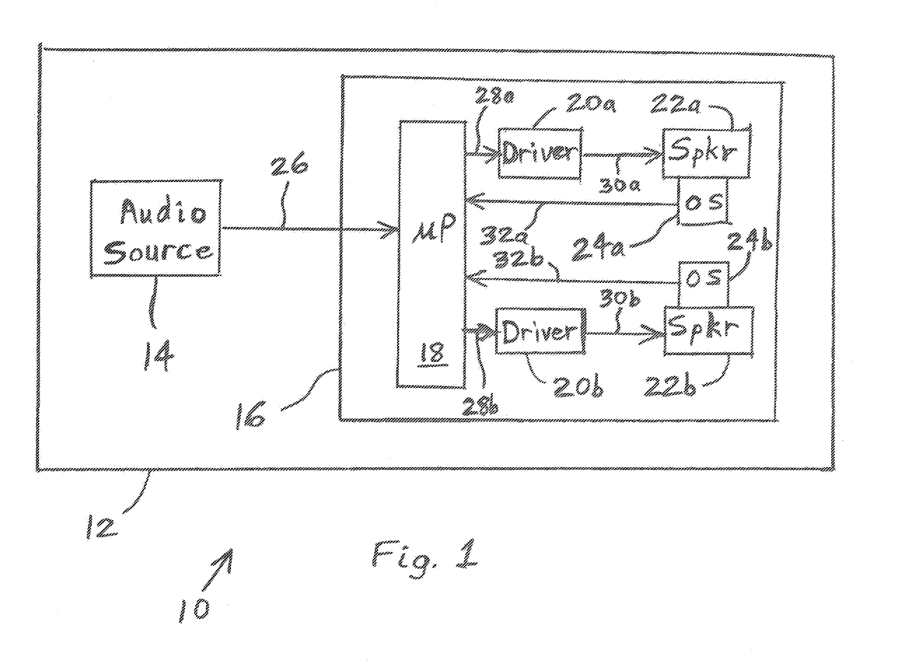

FIG. 1 illustrates one embodiment of a vehicular headphone arrangement 10 of the present invention for a motor vehicle 12. Arrangement 10 includes an audio source 14 and headphones 16. Audio source 14 may be a source of audio content, such as a radio, compact disc player, MP3 player, smartphone, etc.

Headphones 16 includes an electronic processor 18, audio drivers 20a-b, speakers 22a-b, and orientation sensors 24a-b. Processor 18 receives audio content signals 26 from audio source 14, and transmits first audio signals 28a-b based thereon to drivers 20a-b. Drivers 20a-b may each include an amplifier driving a drive unit. Drivers 20a-b may transmit to speakers 22a-b second audio signals 30a-b based on first audio signals 28a-b. Speakers 22a-b may then audibly play second audio signals 30a-b, respectively.

Orientation sensors 24a-b may be in the form of gyroscopes, accelerometers and/or magnetometers, for example. Orientation sensors 24a-b may determine the orientations of speakers 22a-b and transmit signals 32a-b indicative thereof to processor 18. Processor 18 may then adjust the settings of the amplifiers of drivers 20a-b based upon signals 32a-b.

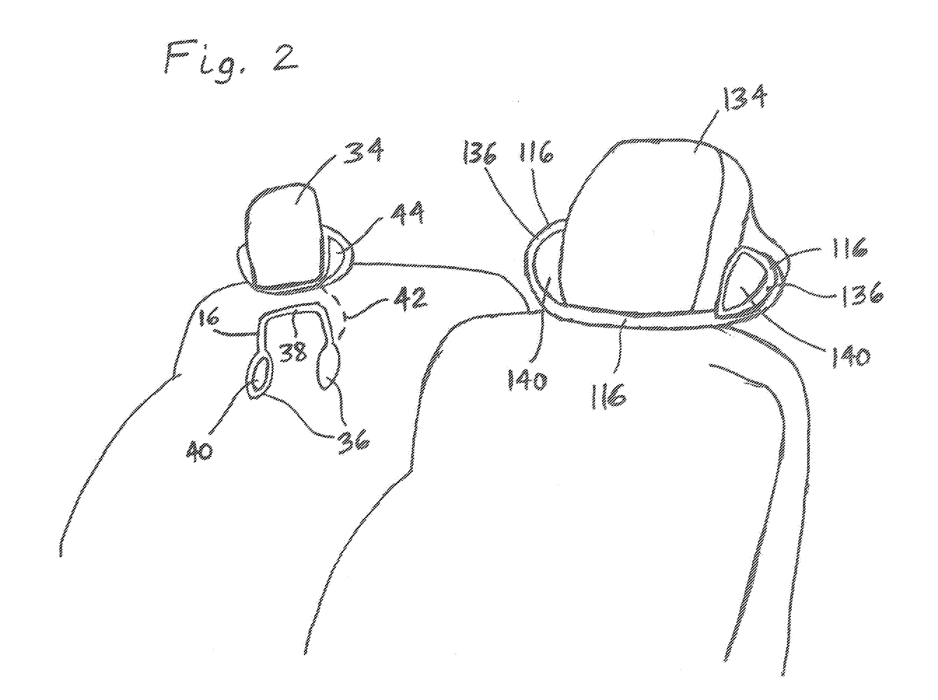

FIG. 2 illustrates the headphones 16 and a seat headrest 34 in which headphones 16 may be installed. Headphones 16 include two earcups 36 interconnected by a headband 38. Each earcup 36 includes a respective speaker 40 that faces inwardly while in use as headphones. Headphones 16 may be communicatively coupled to vehicle 12 via an optional wire 42 or wirelessly. Headrest 34 includes a recess 44 in which headphones 16 may be retained while ire nonuse or while being used as speakers. For example, headphones 116 are shown as being retained in an adjacent headrest 134 with earcups 136 being rotated ninety degrees from the position in which speakers 140 face inwardly such that both speakers 140 face forward in vehicle 12.

Orientation sensors 24a-b may sense whether the speakers are facing inwardly or facing forward. Processor 18 may then adjust the settings of the amplifiers of drivers 20a-b based upon whether the speakers are facing inwardly or facing forward. For example, the volume of the audible sounds played by the speakers may be reduced in response to the speakers being moved from the forward-facing position to the inwardly facing position in order to avoid damaging the wearer's hearing.

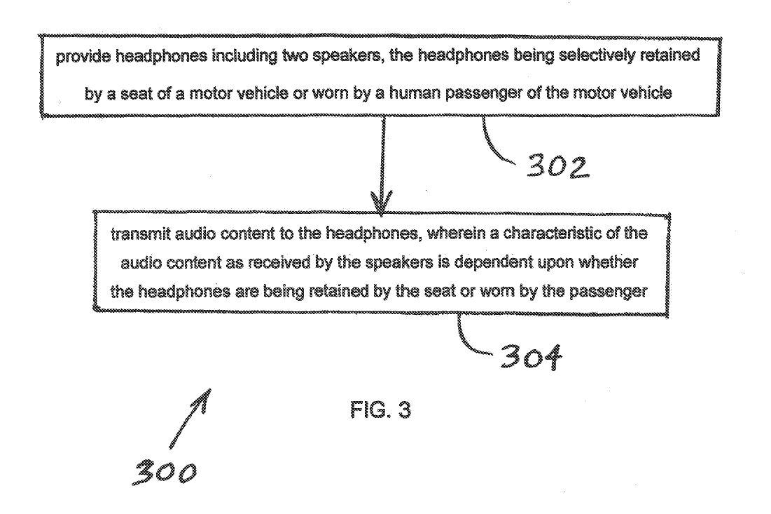

FIG. 3 illustrates one embodiment of an audio method 300 of the present invention for a motor vehicle. In a first step 302, headphones including two speakers are provided. The headphones are selectively retained by a seat of the motor vehicle or worn by a human passenger of the motor vehicle. For example, headphones 16 including two speakers 40 may be retained by or removed from a headrest 34 of a seat of a motor vehicle 12. When headphones 16 are removed from headrest 34, headphones 16 may be worn on the head of a human passenger within motor vehicle 12.

In a final step 304, audio content is transmitted to the headphones. A characteristic of the audio content as received by the speakers is dependent upon whether the headphones are being retained by the seat or worn by the passenger. For example, audio content may be transmitted from audio source 14 to headphones 16. Orientation sensors 24a-b may sense whether speakers 22a-b are facing inwardly, indicating that headphones 16 are being worn by a passenger, or facing forward, indicating that headphones 16 are being retained by the seat. A characteristic of the audio content, such as volume, as received by the speakers may be dependent upon whether headphones 16 are being retained by the seat or are being worn by the passenger. That is, processor 18 may adjust the settings of the amplifiers of drivers 20a-b to reduce the volume of the audible sounds played by the speakers if headphones 16 are being worn by the passenger, and to increase the volume of the audible sounds played by the speakers if headphones 16 are being retained by the seat.

The inventive headphones have been described as including orientation sensors to determine whether the headphones are being worn on a user's head or are being used as speakers. However, in other embodiments of the invention, a switch sensor makes this determination. For example, a switch sensor may be located at the interface between the earcup and head band to detect the orientation of the earcup relative to the headband. As another example, a switch sensor may be located in the recess of the seat to detect when the headphones are retained within the recess and thus are being used as speakers. As yet another example, a switch sensor or other type of sensor may be located on the earcup, facing in the same direction as the speaker. This sensor may detect when a user's head is being pressed against the earcup.

The inventive headphones have been described as communicating with the vehicle via infrared signals. However, it is within the scope of the invention for the headphones to connect to the vehicle via Bluetooth or WiFi instead of infrared communication. It is further possible for the inventive headphones to use wired communication in order to lower cost, improve audio performance, and reduce headphone weight.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle comprising:
a seat;
headphones including two speakers and configured to be selectively retained by the seat or worn by a human passenger of the motor vehicle; and
an audio source communicatively coupled to the headphones and configured to provide audio content to the headphones, wherein a characteristic of the audio content as received by the speakers is dependent upon whether the headphones are being retained by the seat or worn by the passenger.

2. The vehicle of claim 1 wherein the seat includes a recess configured to retain the headphones.

3. The vehicle of claim 1 wherein the headphones include two earcups interconnected by a headband, each said earcup retaining a respective said speaker, the speakers facing forward when the headphones are being retained by the seat, and the speakers facing each other when the headphones are being worn by the passenger.

4. The vehicle of claim 1 further comprising an orientation sensor configured to detect an orientation of at least one part of the headphones, wherein the characteristic of the audio content as received by the speakers is dependent upon the detected orientation of the at least one part of the headphones.

5. The vehicle of claim 1 wherein the characteristic of the audio content as received by the speakers includes a setting of an amplifier of the headphones.

6. The vehicle of claim 1 wherein the characteristic of the audio content as received by the speakers includes a loudness of the audio content.

7. The vehicle of claim 1 wherein the seat includes a headrest, the headphones being configured to be selectively retained by the headrest or worn by a human passenger of the motor vehicle.

8. An audio method for a motor vehicle comprises:
providing headphones including two speakers, the headphones being configured to be selectively retained by a seat of the motor vehicle or worn by a human passenger of the motor vehicle; and
transmitting audio content to the headphones, wherein a characteristic of the audio content as received by the speakers is dependent upon whether the headphones are being retained by the seat or worn by the passenger.

9. The method of claim 8 further comprising retaining the headphones in a recess of the seat.

10. The method of claim 8 wherein the headphones include two earcups interconnected by a headband, each said earcup retaining a respective said speaker, the speakers facing forward when the headphones are being retained by the seat, and the speakers facing each other when the headphones are being worn by the passenger.

11. The method of claim 8 further comprising detecting an orientation of at least one part of the headphones, wherein the characteristic of the audio content as received by the speakers is dependent upon the detected orientation of the at least one part of the headphones.

12. The method of claim 8 wherein the characteristic of the audio content as received by the speakers includes a setting of an amplifier of the headphones.

13. The method of claim 8 wherein the characteristic of the audio content as received by the speakers includes a loudness of the audio content.

14. The method of claim 8 wherein the seat includes a headrest, the headphones being configured to be selectively retained by the headrest or worn by a human passenger of the motor vehicle.

15. A motor vehicle comprising:
a seat;
headphones including two driver devices and two speakers, each driver device being configured to drive a respective one of the speakers, the headphones being configured to be selectively retained by the seat or worn by a human passenger of the motor vehicle;
means for determining whether the headphones are being retained by the seat or are being worn by the passenger; and
an audio source communicatively coupled to the headphones and configured to provide audio content to the headphones, wherein an electronic parameter of the two driver devices is dependent upon whether the headphones are being retained by the seat or are being worn by the passenger as determined by the determining means.

16. The vehicle of claim 15 wherein the seat includes a recess configured to retain the headphones.

17. The vehicle of claim 15 wherein the headphones include two earcups interconnected by a headband, each said earcup retaining a respective said speaker, the speakers facing forward when the headphones are being retained by the seat, and the speakers facing each other when the headphones are being worn by the passenger.

18. The vehicle of claim 15 wherein the determining means comprises an orientation sensor configured to detect an orientation of at least one part of the headphones, wherein the electronic parameter of the two driver devices is dependent upon the detected orientation of the at least one part of the headphones.

19. The vehicle of claim 15 wherein the characteristic of the audio content as received by the speakers includes a setting of amplifiers of the driver devices or a loudness of the audio content.

20. The vehicle of claim 15 wherein the seat includes a headrest, the headphones being configured to be selectively retained by the headrest or worn by a human passenger of the motor vehicle.
